(19) United States
(12) Patent Application Publication
(10) Pub. No.: US 2025/0353566 A1
(43) Pub. Date: Nov. 20, 2025

(54) VEHICLE BODY COVER

(71) Applicant: SUZUKI MOTOR CORPORATION, Hamamatsu-shi (JP)

(72) Inventor: Noboru UNEZAWA, Hamamatsu-shi (JP)

(73) Assignee: SUZUKI MOTOR CORPORATION, Hamamatsu-shi (JP)

(21) Appl. No.: 19/170,766

(22) Filed: Apr. 4, 2025

(30) Foreign Application Priority Data
May 15, 2024 (JP) 2024-079469

(51) Int. Cl. B62K 11/02; B62J 11/22; B62J 40/00

(52) U.S. Cl. CPC B62K 11/02; B62J 11/22; B62J 40/00

(57) ABSTRACT

A vehicle body cover that covers a vehicle body frame from an outside in a vehicle width direction under a seat. The vehicle body cover includes a frame cover positioned outside the vehicle body frame in the vehicle width direction, and a side cover positioned outside the frame cover in the vehicle width direction. The frame cover is recessed toward an inside in the vehicle width direction to form a storage portion for an on-vehicle tool. The side cover covers the storage portion from the outside in the vehicle width direction.

### CROSS-REFERENCE TO RELATED APPLICATIONS

This application is based on and claims priority under 35 USC 119 from Japanese Patent Application No. 2024-079469 filed on May 15, 2024, the entire content of which is incorporated herein by reference.

### TECHNICAL FIELD

The present disclosure relates to a vehicle body cover.

### BACKGROUND ART

Straddle-type vehicles are known in the related art in which a tool box provided in a vehicle body is covered by a vehicle body cover (see, for example, JPS61-113576A). In a straddle-type vehicle described in JPS61-113576A, a main frame extends rearward from a head pipe, and a rear portion of the main frame is bent downward to form a body frame. A seat rail extends rearward from an upper portion of the body frame, and a backstay extends from a lower portion of the body frame, with a rear end of the backstay being joined to a rear end of the seat rail. A tool box is fixed to the backstay, and the tool box is covered from an outside in a vehicle width direction by the vehicle body cover.

In order to withstand deformation caused by knee grip of a rider, the vehicle body cover needs to be made thicker, provided with ribs and the like to ensure rigidity, but increasing a thickness and the like increases a weight of the vehicle body cover. When a tool box is fixed to the backstay, it is necessary to cover the tool box with a vehicle body cover to improve appearance, but depending on a size of the tool box, the vehicle body cover becomes large and heavy. Depending on where the tool box is mounted, it may be difficult to provide the vehicle body cover with appropriate rigidity.

### SUMMARY OF INVENTION

Aspect of non-limiting embodiments of the present disclosure relates to provide a vehicle body cover that ensures rigidity and can properly store an on-vehicle tool.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a vehicle body cover that covers a vehicle body frame from an outside in a vehicle width direction under a seat, the vehicle body cover including:
a frame cover positioned outside the vehicle body frame in the vehicle width direction; and
a side cover positioned outside the frame cover in the vehicle width direction,
in which the frame cover is recessed toward an inside in the vehicle width direction to form a storage portion for an on-vehicle tool, and
the side cover covers the storage portion from the outside in the vehicle width direction.

### BRIEF DESCRIPTION OF DRAWINGS

Exemplary embodiment(s) of the present invention will be described in detail based on the following figures, wherein:

FIG. 1 is a left side view of a straddle-type vehicle according to the present embodiment;

FIG. 2 is a left side view of a vehicle rear portion according to the present embodiment;

FIG. 3 is a left side view of the vehicle rear portion with a rear side cover removed according to the present embodiment; and

FIG. 4 is a cross-sectional view of the vehicle rear portion shown in FIG. 2 taken along a line IV-IV.

### DESCRIPTION OF EMBODIMENTS

A vehicle body cover according to one aspect of the present disclosure covers a vehicle body frame in a vehicle width direction, under a seat. The vehicle body cover includes a frame cover outside the vehicle body frame in a vehicle width direction, and a side cover outside the frame cover in the vehicle width direction. The frame cover is recessed toward an inside in the vehicle width direction to form a storage portion for an on-vehicle tool. The side cover covers the storage portion from an outside in the vehicle width direction. The storage portion for an on-vehicle tool is formed in the frame cover, so that a cross section of the cover has an uneven shape, thereby increasing rigidity of the frame cover. Since the storage portion of the frame cover is covered by the side cover, the vehicle body cover becomes a double structure, thereby increasing the rigidity. Therefore, the rigidity of the vehicle body cover is ensured and the on-vehicle tool is properly stored in the vehicle body cover.

### EMBODIMENT

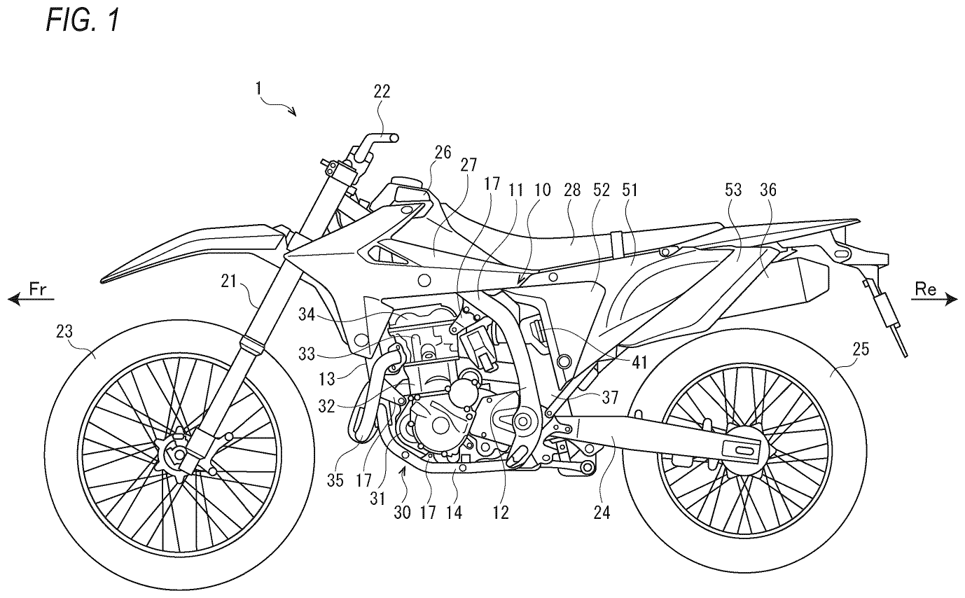

Hereinafter, a straddle-type vehicle including a vehicle body cover according to the present embodiment will be described with reference to the accompanying drawings. FIG. 1 is a left side view of a straddle-type vehicle according to the present embodiment. In the following drawings, an arrow Fr indicates a vehicle front side, an arrow Re indicates a vehicle rear side, an arrow L indicates a vehicle left side, and an arrow R indicates a vehicle right side.

As shown in FIG. 1, a straddle-type vehicle 1 is implemented by mounting various components such as an engine 30 and an electrical system on a vehicle body frame 10. A pair of main frames 11 extend diagonally rearward and downward from a head pipe (not shown) of the vehicle body frame 10. Rear portions of the pair of main frames 11 form a pair of body frames 12 bent downward. A down frame 13 extends downward from the head pipe. An under loop 14 bent rearward is connected to a lower portion of the down frame 13. Rear ends of the pair of under loops 14 are connected to lower portions of the pair of body frames 12, so that the vehicle body frame 10 is formed into a cradle shape.

A front fork 21 is steerably supported by the head pipe via a steering shaft (not shown). A handle 22 is provided at an upper portion of the front fork 21. A front wheel 23 is rotatably supported by a lower portion of the front fork 21. A fuel tank 26 is placed over the upper portions of the pair of main frames 11. The main frames 11 and the fuel tank 26 are covered by front side covers 27 from lateral sides. A seat 28 is mounted behind the fuel tank 26. A frame cover 51, a rear side cover 52, and a parts cover 53 are mounted under the seat 28.

A swing arm 24 is supported by the body frame 12 so as to be configured to swing. The swing arm 24 extends rearward from the body frame 12. A rear wheel 25 is rotatably supported by a rear end of the swing arm 24. The engine 30 is coupled to the rear wheel 25 via a chain drive type transmission mechanism (not shown). Power from the engine 30 is transmitted to the rear wheel 25 via the transmission mechanism. A rear suspension 37 is coupled to the swing arm 24, and by expansion and contraction of the rear suspension 37, unevenness on a road surface is absorbed, so as to prevent vibration and improve a grounding property of the rear wheel 25 with the road surface.

The engine 30 is a four-stroke, single-cylinder engine, and is suspended inside the vehicle body frame 10 via a suspension bracket 17. A cylinder assembly in which a cylinder 32, a cylinder head 33, and a cylinder head cover 34 are stacked is attached to an upper portion of a crankcase 31 of the engine 30. An exhaust pipe 35 is connected to a front surface of the cylinder head 33. The exhaust pipe 35 extends rearward passing through a right side of the cylinder 32, and an up-type muffler 36 tilted diagonally upward and rearward is connected to a downstream end of the exhaust pipe 35. An intake device such as an air cleaner 41 is mounted behind the cylinder head 33.

By the way, vehicle body covers such as the rear side cover and the frame cover are pressed inward in the vehicle width direction by knee grip of a rider. For this reason, in order to prevent deformation of the vehicle body cover, the rigidity is increased by increasing a thickness of the vehicle body cover, providing ribs on a back side of the vehicle body cover, or folding back ends of the vehicle body cover. In a typical straddle-type vehicle, on-vehicle tools such as box spanners and screwdrivers are stored under the seat or in a dedicated tool box. The tool box may be mounted directly above a rear fender or fixed to a seat frame.

However, in a case of models in which there is insufficient space under the seat, such as off-road vehicles, it is difficult to mount the on-vehicle tools under the seat. When storing the on-vehicle tools in a dedicated tool box, not only a weight of the tool box and the number of parts increase, but the weight of the vehicle body cover also increases due to the need to increase the thickness of the vehicle body cover and providing ribs and the like for ensuring the rigidity. If the tool box is exposed to the outside, appearance of a vehicle will be deteriorated. Therefore, in the present embodiment, the vehicle body cover has a double structure, an inner cover is partially recessed to store the on-vehicle tools, and an uneven shape of this recess is utilized to ensure the rigidity of the cover.

In off-road vehicles, due to factors such as a capacity of a fuel tank, an air cleaner is often mounted on a seat frame, and an intake port of the air cleaner is often disposed under the seat. Since air is drawn into the air cleaner through a gap between the seat and the vehicle body cover, there is a risk that foreign objects such as dust kicked up by the front wheel may enter the intake port. Simply sealing the gap between the seat and the vehicle body cover will narrow an intake path, resulting in poor output. Therefore, in the present embodiment, a labyrinth structure is formed in the intake path by utilizing an outer surface shape of the air cleaner and the recess of the vehicle body cover to prevent foreign matters from entering the intake port.

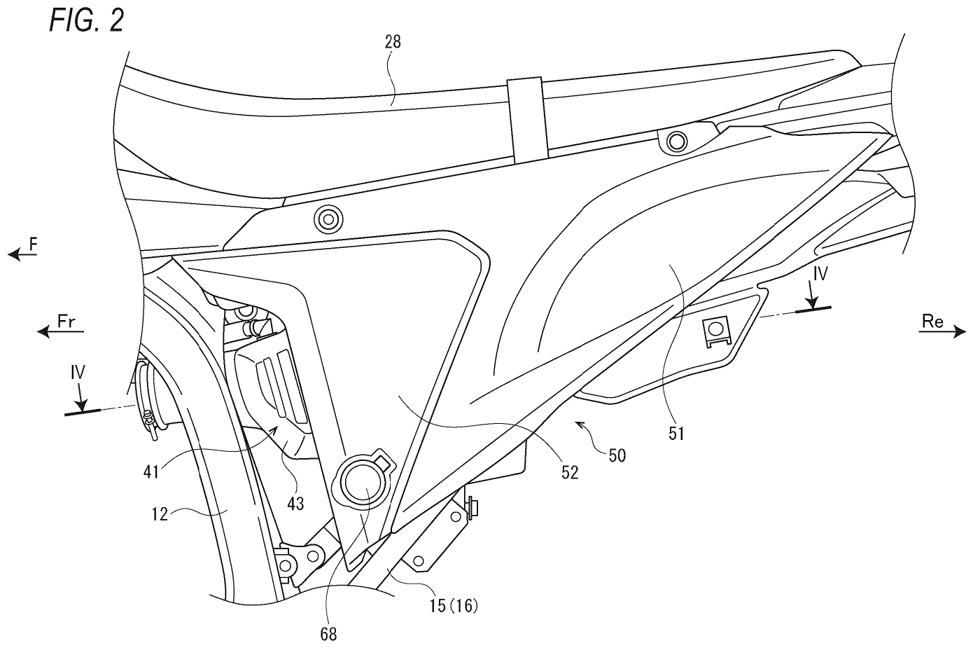

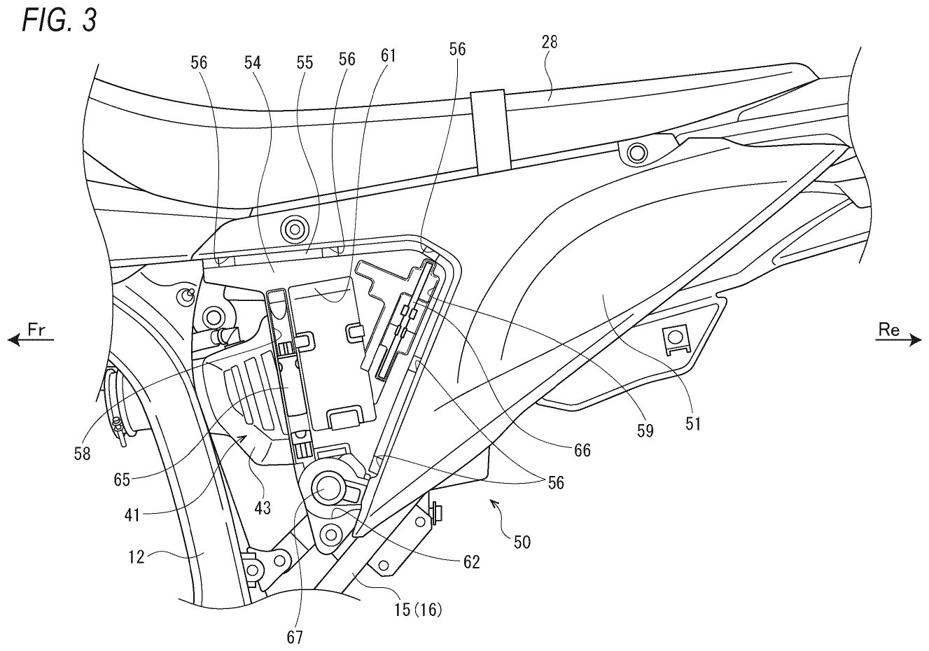

The vehicle body cover will be described with reference to FIGS. 2 and 3. FIG. 2 is a left side view of a vehicle rear portion according to the present embodiment. FIG. 3 is a left side view of the vehicle rear portion with the rear side cover removed according to the present embodiment.

As shown in FIG. 2, a seat frame 15 is attached to a rear portion of the body frame 12 as a part of the vehicle body frame. The seat frame 15 supports the seat 28 from below. A vehicle body cover 50 is mounted below the seat 28. The seat frame 15 in covered from the outside in the vehicle width direction by the vehicle body cover 50. The vehicle body cover 50 is formed by mounting the rear side cover (side cover) 52 on a front outer surface of the frame cover 51. The air cleaner 41 is mounted inside the seat frame 15 under the seat 28. An outlet tube 43 in front of the air cleaner 41 protrudes forward from a front edge of the rear side cover 52.

As shown in FIGS. 2 and 3, the frame cover 51 having a substantially triangular shape in a side view is positioned on the outside in the vehicle width direction of the seat frame 15. An upper edge of the frame cover 51 extends along an upper rail (not shown) of the seat frame 15, and a lower edge of the frame cover 51 extends along a lower rail 16 of the seat frame 15, so that the frame cover 51 entirely covers the seat frame 15. A front side of the frame cover 51 is recessed to the inside in the vehicle width direction to form a mounting surface 54 for the rear side cover 52. By mounting the rear side cover 52 on this mounting surface 54, the seat frame 15 and the rear side cover 52 are formed to have a design with a sense of unity.

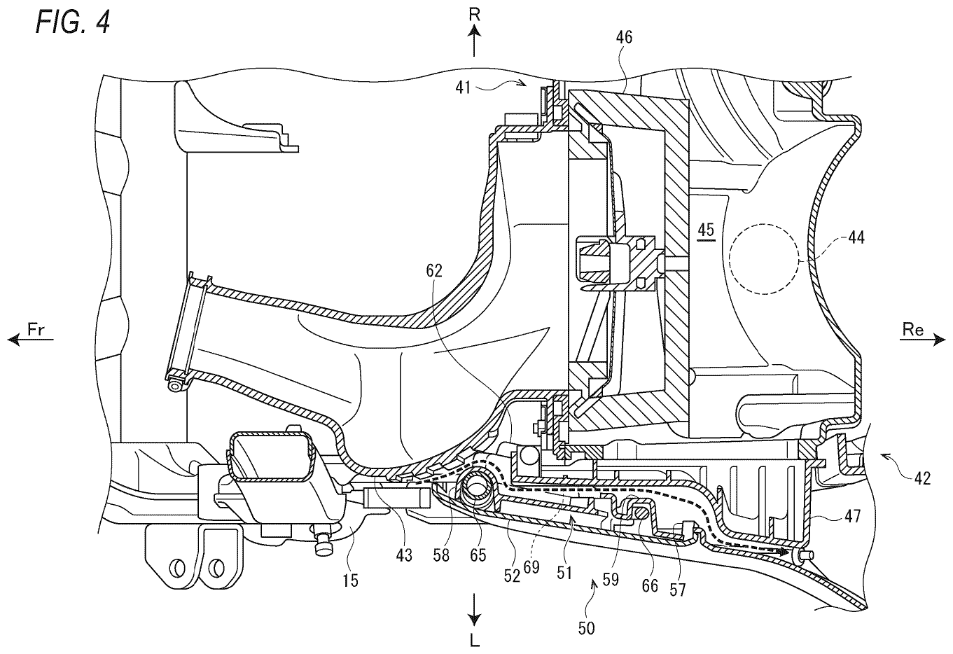

The mounting surface 54 is formed in a substantially triangular shape in a side view, with an upper-lower dimension decreasing from a front edge of the frame cover 51 toward a vicinity of a center. A shallow groove 55 extends along upper and rear sides of the mounting surface 54, and a plurality of fastening holes 56 are provided on the shallow groove 55 at predetermined intervals. The rear side cover 52 is formed in approximately the same shape as the mounting surface 54. The rear side cover 52 is fastened to the frame cover 51 by inserting fastening pieces 57 (see FIG. 4) on the upper edge and the rear edge of the rear side cover 52 into the plurality of fastening holes 56 in the mounting surface 54. In this way, the rear side cover 52 is positioned on the outside of the frame cover 51 in the vehicle width direction, so that a front side of the vehicle body cover 50 is formed into a double structure.

The mounting surface 54 of the frame cover 51 is recessed to the inside in the vehicle width direction. The frame cover 51 is formed with a plurality of storage portions 58 and 59 for on-vehicle tools individually. The storage portion 58 extends along a front edge of the mounting surface 54. The storage portion 59 extends along a rear edge of the mounting surface 54. The storage portion 58 is configured to store a box spanner 65 as an on-vehicle tool. The storage portion 59 is configured to store a screwdriver 66 as an on-vehicle tool. Between the storage portions 58 and 59, the mounting surface 54 is recessed slightly to the inside in the vehicle width direction to form a storage portion 61 in the frame cover 51, in which thin items such as a vehicle inspection certificate can be stored. The recess of the storage portion 58 is the deepest, the recess of the storage portion 59 is the next deepest, and the recess of the storage portion 61 is the shallowest.

The mounting surface 54 of the frame cover 51 is recessed to the inside in the vehicle width direction, and a recess 62 for a key cylinder 67 is formed on the frame cover 51. The recess 62 is positioned under the storage portion 58. The recess 62 is recessed more inward in the vehicle width direction than the storage portions 58, 59, and 61. When the rear side cover 52 is mounted on the frame cover 51, the rear side cover 52 covers the storage portions 58, 59, 61 from the outside in the vehicle width direction. The key cylinder 67 is attached to the rear side cover 52 in correspondence with the recess 62 of the frame cover 51, and the rear side cover 52 is fixed to the frame cover 51 by the key cylinder 67. The key cylinder 67 is covered by a key cap 68 provided on an outer surface of the rear side cover 52.

During knee grip, a grip position where knees of the rider come into contact is positioned near the rear side cover 52. The front side of the frame cover 51 is positioned inside the rear side cover 52, and the rear side cover 52 and the frame cover 51 constitute a double structure of the vehicle body cover 50, which increases its rigidity. The storage portions 58, 59, 61 and the recess 62 are individually formed on the mounting surface 54 inside the frame cover 51, and a cross section of the cover has a complex uneven shape, which further increases the rigidity of the vehicle body cover 50. That is, the storage portions 58, 59, 61 and the recess 62 function as a plurality of reinforcing ribs on a back side of the frame cover 51.

The storage portions 58 and 59 are formed to match a long tool shape of the box spanner 65 and the screwdriver 66. A longitudinal direction of the storage portion 58 is oriented in the upper-lower direction. A longitudinal direction of the storage portion 59 is tilted rearward. Even when the grip position during knee grip varies in the upper-lower direction depending on a physique of the rider, the uneven shape of the frame cover 51 makes it easy to find the grip position, and can effectively withstand deformation caused by knee grip. The storage portions 58 and 59 are formed to match the shapes of the box spanner 65 and the screwdriver 66, and the individual storage portions 58, 59, and 61 are arranged compactly, thereby increasing a degree of freedom in the shape of the vehicle body cover 50.

The intake path to the intake port on the inside of the vehicle body cover will be described with reference to FIGS. 3 and 4. FIG. 4 is a cross-sectional view of the vehicle rear portion shown in FIG. 2 taken along a line IV-IV.

As shown in FIGS. 3 and 4, the air cleaner 41 is covered from the outside in the vehicle width direction by the vehicle body cover 50 (the frame cover 51). An intake port 44 is formed on an upper surface of a rear portion of a cleaner case 42 of the air cleaner 41. The outlet tube 43 is mounted on a front surface of the cleaner case 42. A filter 46 is mounted in an intake chamber 45 inside the cleaner case 42. The intake chamber 45 of the cleaner case 42 is connected to an intake passage of the outlet tube 43 via the filter 46. A left side surface of the cleaner case 42 is provided with a side cap 47. The filter 46 can be replaced periodically by removing the side cap 47.

An intake path 69 from the front side of the vehicle body cover 50 toward the intake port 44 is formed between the vehicle body cover 50 and the air cleaner 41. The outlet tube 43 curves forward and leftward, and the storage portion 58 of the frame cover 51 is positioned between the outlet tube 43 and the side cap 47 of the cleaner case 42. The storage portion 58 of the frame cover 51 is in front of the intake port 44 of the air cleaner 41 and inside a left side surface of the side cap 47 in the vehicle width direction. A left side surface of the outlet tube 43, the storage portion 58 of the frame cover 51, and the left side surface of the side cap 47 form a U-shaped curve near an inlet of the intake path 69.

The storage portion 59 of the frame cover 51 faces a front portion of the side cap 47 in the vehicle width direction. A rear portion of the side cap 47 bulges outward in the vehicle width direction of the storage portion 59 of the frame cover 51. The storage portion 59 of the frame cover 51 and the step of the side cap 47 cause a midway portion of the intake path 69 to be curved in a crank shape. In this way, a labyrinth structure is formed in the intake path 69 by the storage portions 58, 59 of the frame cover 51, the outlet tube 43, and the side cap 47, making it difficult for foreign matters such as dust and sand to pass through the intake path 69 from the front side of the vehicle body toward the intake port 44.

The recess 62 of the frame cover 51 is positioned lower than the storage portion 58 and the outlet tube 43, and the recess 62 is recessed inward in the vehicle width direction of the storage portion 58 and an outer surface of the outlet tube 43. A labyrinth structure is formed in the intake path 69 by the recess 62 of the frame cover 51, the outlet tube 43, and the cleaner case (side cap) 42, making it difficult for foreign matters to pass through the intake path 69 from the lower side of the vehicle body toward the intake port 44. In this way, the uneven shape of the storage portions 58, 59 and the recess 62 of the frame cover 51 ensures rigidity and prevents foreign matters from entering the intake port 44.

As described above, according to the vehicle body cover 50 of the present embodiment, the storage portions 58, 59 for on-vehicle tools are formed in the frame cover 51, so that the cross section of the cover has an uneven shape, thereby increasing the rigidity of the frame cover 51. Since the storage portions 58, 59 of the frame cover 51 are covered by the rear side cover 52, the vehicle body cover 50 has a double structure, thereby increasing the rigidity. Therefore, the rigidity of the vehicle body cover 50 is ensured and the on-vehicle tools are properly stored in the vehicle body cover 50.

Note that in the present embodiment, the frame cover is formed with a plurality of storage portions for on-vehicle tools, but it is sufficient that the frame cover is formed with at least one storage portion.

In the present embodiment, the on-vehicle tools are formed to be long, but the shape of the on-vehicle tools is not particularly limited. Although the above description has been given of a configuration in which the on-vehicle tools are a box spanner and a screwdriver, the on-vehicle tools are not particularly limited.

In the present embodiment, the vehicle body cover is constituted by the frame cover and the rear side cover, but the vehicle body cover may be constituted by three or more components.

In the present embodiment, the rear side cover is fixed to the frame cover by the key cylinder, but the method for fixing the frame cover and the rear side cover is not particularly limited.

The vehicle body cover according to the present embodiment is not limited to the above-described straddle-type vehicle, and may be used in other types of straddle-type vehicles.

As described above, a first aspect is a vehicle body cover (50) that covers a vehicle body frame (seat frame 15) from an outside in a vehicle width direction under a seat (28), the vehicle body cover including: a frame cover (51) positioned outside the vehicle body frame in the vehicle width direction; and a side cover (rear side cover 52) positioned outside the frame cover in the vehicle width direction, in which the frame cover is recessed toward an inside in the vehicle width direction to form a storage portion (58, 59) for an on-vehicle tool (box spanner 65, screwdriver 66), and the side cover covers the storage portion from the outside in the vehicle width direction. With this configuration, the storage portion for an on-vehicle tool is formed in the frame cover, so that a cross section of the cover has an uneven shape, thereby increasing rigidity of the frame cover. Since the storage portion of the frame cover is covered by the side cover, the vehicle body cover becomes a double structure, thereby increasing the rigidity. Therefore, the rigidity of the vehicle body cover is ensured and the on-vehicle tool is properly stored in the vehicle body cover.

In a second aspect, according to the first aspect, a plurality of storage portions for an on-vehicle tool are formed separately in the frame cover. With this configuration, the storage portions for an on-vehicle tool are individually formed in the frame cover, so that a cross section of the cover has a complicated uneven shape, thereby further increasing rigidity of the frame cover. The storage portions are formed to match the shape of each on-vehicle tool, and the individual storage portions are compactly mounted in the frame cover, thereby increasing the degree of freedom in the shape of the vehicle body cover.

In a third aspect, according to the first aspect or the second aspect, the storage portion is formed to fit a long on-vehicle tool, and a longitudinal direction of the storage portion is oriented in an upper-lower direction. With this configuration, even when the grip position during knee grip varies in the upper-lower direction depending on a physique of the rider, the uneven shape of the frame cover makes it easy to find the grip position, and can effectively withstand deformation caused by knee grip.

In a fourth aspect, according to any one of the first aspect to the third aspect, an air cleaner (41) is mounted under the seat, the frame cover covers the air cleaner from the outside in the vehicle width direction, and the storage portion is recessed inward of an outer surface of the air cleaner in the vehicle width direction, in front of an intake port (44) of the air cleaner and inward in the vehicle width direction. With this configuration, a labyrinth structure is formed in the intake path by the storage portion of the frame cover and the air cleaner, making it difficult for foreign matters such as sand and dust to flow toward the intake port.

In a fifth aspect, according to the fourth aspect, the air cleaner includes a cleaner case (42) formed with the intake port and an outlet tube (43) mounted on a front surface of the cleaner case, and the storage portion is positioned between the cleaner case and the outlet tube. With this configuration, a labyrinth structure is formed in the intake path by the storage portion of the frame cover, the outlet tube, and the cleaner case, making it difficult for foreign matters such as dust and sand to flow from the front side of the vehicle body toward the intake port.

In a sixth aspect, according to any one of the first aspect to the fifth aspect, the frame cover is recessed toward the inside in the vehicle width direction to form a recess (62) for a key cylinder (67), and the recess is positioned under the storage portion and is recessed inward in the vehicle width direction of the storage portion. With this configuration, the recess for the key cylinder is formed in the frame cover, so that a cross section of the cover has an uneven shape, thereby further increasing the rigidity of the frame cover. A labyrinth structure is formed in the intake path by the recess and the storage portion of the frame cover, making it difficult for foreign matters such as sand and dust to flow from the front side and the lower side of the vehicle body toward the intake port.

In a seventh aspect, according to the fifth aspect, the frame cover is recessed toward the inside in the vehicle width direction to form a recess for a key cylinder, and the recess is positioned under the outlet tube and is recessed inward of an outer surface of the outlet tube in the vehicle width direction. With this configuration, the recess for the key cylinder is formed in the frame cover, so that a cross section of the cover has an uneven shape, thereby further increasing the rigidity of the frame cover. A labyrinth structure is formed in the intake path by the recess of the frame cover and the outlet tube, making it difficult for foreign matters such as dust and sand to flow from the lower side of the vehicle body toward the intake port.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A vehicle body cover that covers a vehicle body frame from an outside in a vehicle width direction under a seat, the vehicle body cover comprising:
a frame cover positioned outside the vehicle body frame in the vehicle width direction; and
a side cover positioned outside the frame cover in the vehicle width direction,
wherein the frame cover is recessed toward an inside in the vehicle width direction to form a storage portion for an on-vehicle tool, and
the side cover covers the storage portion from the outside in the vehicle width direction.

2. The vehicle body cover according to claim 1,
wherein a plurality of storage portions for an on-vehicle tool are formed separately in the frame cover.

3. The vehicle body cover according to claim 1,
wherein the storage portion is formed to fit a long on-vehicle tool, and
a longitudinal direction of the storage portion is oriented in an upper-lower direction.

4. The vehicle body cover according to claim 1,
wherein an air cleaner is mounted under the seat,
the frame cover covers the air cleaner from the outside in the vehicle width direction, and
the storage portion is recessed inward of an outer surface of the air cleaner in the vehicle width direction, in front of an intake port of the air cleaner.

5. The vehicle body cover according to claim 4,
wherein the air cleaner includes:
a cleaner case formed with the intake port; and
an outlet tube mounted on a front surface of the cleaner case, and
the storage portion is positioned between the cleaner case and the outlet tube.

6. The vehicle body cover according to claim 1,
wherein the frame cover is recessed toward the inside in the vehicle width direction to form a recess for a key cylinder, and
the recess is positioned under the storage portion and is recessed inward in the vehicle width direction of the storage portion.

7. The vehicle body cover according to claim 5,
wherein the frame cover is recessed toward the inside in the vehicle width direction to form a recess for a key cylinder, and
the recess is positioned under the outlet tube and is recessed inward of an outer surface of the outlet tube in the vehicle width direction.
